(19) United States
(12) Patent Application Publication
(10) Pub. No.: US 2025/0342003 A1
(43) Pub. Date: Nov. 6, 2025

(54) Communication Method and Communication Apparatus

(71) Applicant: Telefonaktiebolaget LM Ericsson (publ), Stockholm (SE)

(72) Inventor: Yanping Dang, Beijing (CN)

(21) Appl. No.: 18/862,208

(22) PCT Filed: May 6, 2022
(86) PCT No.: PCT/CN2022/091186

§ 371 Date: Nov. 1, 2024

(51) Int. Cl. G06F 3/16; G10L 15/25; G10L 25/78

(52) U.S. Cl. CPC G06F 3/165; G10L 15/25; G10L 25/78

(57) ABSTRACT

Embodiments of the present disclosure provide communication method and communication apparatus. The communication method may be a method of auto switching muting condition of a participant in a voice related call. The method includes detecting the speaking intention of the participant; and auto switching the muting condition of the participant based on the detected speaking intention of the participant.

### TECHNICAL FIELD

The non-limiting and exemplary embodiments of the present disclosure generally relate to the technical field of communication method and communication apparatus, and specifically to method and apparatus of auto switching muting condition of a participant in a voice related call.

### BACKGROUND

This section introduces aspects that may facilitate a better understanding of the disclosure. Accordingly, the statements of this section are to be read in this light and are not to be understood as admissions about what is in the prior art or what is not in the prior art.

Hereinafter, to facilitate easy reading of the specification, “he” is used to represent “he/she”, “him” is used to represent “him/her” and “his” is used to represent “his/her”.

Currently, online meetings are becoming more and more popular, partially because of COV-19 epidemic. During online meetings, participants normally take turns to speak, without interrupting each other. So when one participant (a first participant) is speaking, other participants normally will mute themselves or be muted by others, e.g., host/chairman of the meeting, so as to keep order of the meeting and do not interfere the speaker. When a second participant wants to speak, he/she needs to unmute himself/herself manually. What often happens is the second participant starts talking without unmuting himself/herself and other participants have to remind the second participant to unmute after waiting a time period wondering whether the second participant is speaking or leaving. Sometimes the first participant may forget to mute himself after speaking, so his afterwards whispering or noise may cause awkward situations. This reduces efficiency and brings bad user experience.

Another situation is participants may have a dialogue, which means participants take turns to speak at short intervals. Normally, the dialogue speakers unmute themselves all the time and keep silent without muting themselves when the dialogue partner is speaking. However, the silent participant is unmuted so background noise of the silent participant may interfere the current speaker. What may also happen is the silent participant does not want other participants to hear sound from his side for privacy reasons. Therefore, the silent participant has to unmute himself when he wants to speak and has to mute himself when he wants to hear. Since it is a dialogue, he needs to mute and unmute many times, which is troublesome.

The same also applies to other voice related calls, like a telephone call made based on telecom operators' voice service, or a voice call based on applications, e.g., WeChat, WhatsApp, or a teleconference call based on teleconferencing devices and services, or an online meeting call based on data service of telecom operators, e.g., Skype meetings, Teams meetings, etc.

There is a need to develop a technology of auto switching muting condition of a participant in a voice related call.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

To overcome or mitigate at least one of the above mentioned problems or other problems or provide a useful solution, embodiments of the present disclosure propose a method and an apparatus of auto switching muting condition of a participant in a voice related call.

In a first aspect of the disclosure, there is provided a method of auto switching muting condition of a participant in a voice related call. The method comprises: detecting the speaking intention of the participant; and auto switching the muting condition of the participant based on the detected speaking intention of the participant.

In an embodiment, the auto switching includes: unmuting the participant in the voice related call when the detected speaking intention of the participant is to speak.

In an embodiment, the auto switching includes: muting the participant in the voice related call when the detected speaking intention of the participant is not to speak.

In an embodiment, the detecting the speaking intention of the participant includes at least one of the following: detecting an existence of a voice; detecting an existence of a voice with a predetermined duration; detecting an existence of a voice with a predetermined volume; detecting an existence of a voice with a predetermined voiceprint; and detecting an existence of a voice from a predetermined direction.

In an embodiment, the detecting the speaking intention of the participant includes at least one of the following: detecting a moving mouth pattern of a face; detecting a moving mouth pattern of a predetermined face; and detecting a moving mouth pattern of a face with a first predetermined orientation.

In an embodiment, the detecting the speaking intention of the participant includes at least one of the following: detecting a disappearance of a voice; detecting a disappearance of a voice with a predetermined duration; detecting a disappearance of a voice with a predetermined voiceprint; and detecting a disappearance of a voice from a predetermined direction.

In an embodiment, the detecting the speaking intention of the participant includes at least one of the following: detecting a stable mouth pattern of a face; detecting a stable mouth pattern of a face with a predetermined duration; detecting a stable mouth pattern of a predetermined face; detecting a stable mouth pattern of a face with a first predetermined orientation; detecting a moving mouth pattern of a face with a second predetermined orientation; detecting a moving mouth pattern of a predetermined face with a second predetermined orientation; detecting a face with a second predetermined orientation; and detecting a predetermined face with a second predetermined orientation.

In an embodiment, the detecting the speaking intention of the participant includes at least one of the following: detecting a predetermined behavior pattern.

In an embodiment, the predetermined behavior pattern includes at least one of: leaving, picking up a phone and holding a phone.

In an embodiment, the voice related call includes at least one of a telephone call, a voice call, a teleconference call and an online meeting call.

In a second aspect of the disclosure, there is provided an apparatus for auto switching muting condition of a participant in a voice related call. The apparatus includes: a communication interface; a processor; and a memory coupled to the processor, said memory containing instructions executable by said processor, whereby the apparatus is operative to perform a method according to the first aspect.

In a third aspect of the disclosure, there is provided a computer-readable storage medium storing instructions which when executed by at least one processor, cause the at least one processor to perform the method according to the first aspect.

With the present invention, a participant of a voice related call can speak when he wants without need to unmute manually and also does not need to mute manually when he does not want to speak. Burden of user can be reduced, privacy can be protected, interference can be avoided, efficiency can be improved and user experience can be increased.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of a method 100 of auto switching muting condition of a participant in a voice related call according to an embodiment of the present disclosure.

FIG. 2 is a block diagram of an apparatus 200 for auto switching muting condition of a participant in a voice related call according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that the terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In the context of the present invention, the term “voice related call” means a call during which participants use at least their voice to communicate with each other, including, but not limited to: a telephone call, a voice call, a teleconference call and/or an online meeting call. The telephone call is made based on telecom operators' voice service, e.g, using a mobile phone, a telephone, a smart phone, a SIM (Subscriber Identity Module) card, an eSIM (Embedded-SIM) card, or the like. The voice call is normally based on applications and is made by using a software like APP (application), such as WeChat, WhatsAPP, or the like. The teleconference call is made based on teleconferencing devices and services provided by corresponding vendors and/or telecom operators. The online meeting call is made based on data service of telecom operators, e.g., Skype meetings, Teams meetings, etc.

In the context of the present invention, muting a participant means stopping sending at least voice data from this participant side to other participants and unmuting a participant means starting sending at least voice data from this participant side to other participants. The voice collection device/module like microphone is always working.

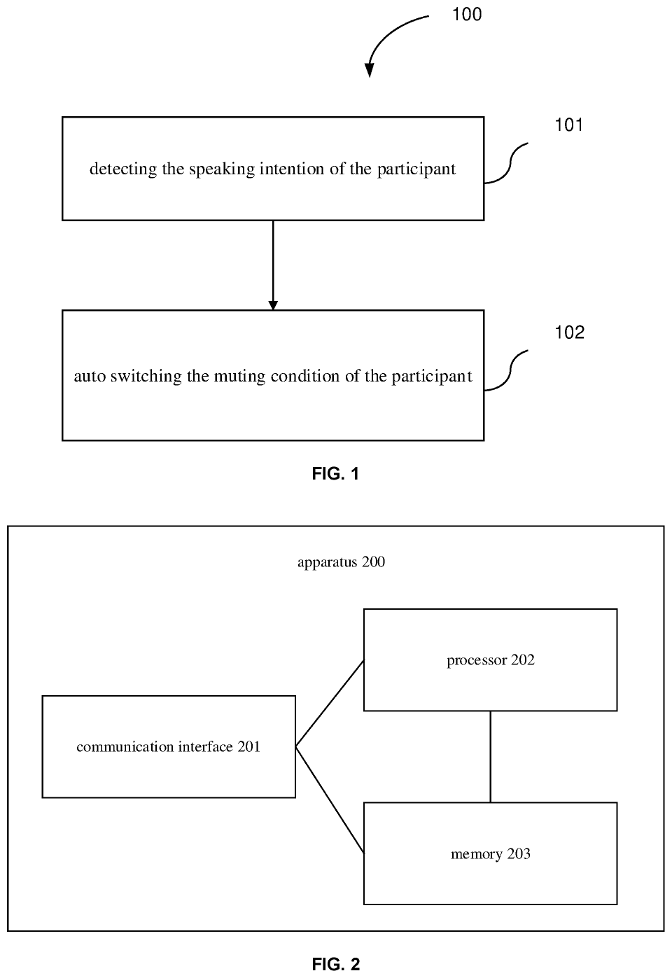

FIG. 1 shows a flowchart of a method 100 of auto switching muting condition of a participant in a voice related call according to an embodiment of the present disclosure.

At block 101, detection of the speaking intention of the participant is made.

That is, detection of whether the participant wants to speak or wants to stop speaking is made.

The following factors can be deemed as an intention of the participant to speak: an existence of a voice; an existence of a voice with a predetermined duration; an existence of a voice with a predetermined volume; an existence of a voice with a predetermined voiceprint, an existence of a voice from a predetermined direction; a moving mouth pattern of a face; a moving mouth pattern of a predetermined face; and/or a moving mouth pattern of a face with a first predetermined orientation.

In an embodiment, detection of an existence of a voice is made. If a (human or human-like) voice rather than a sound is detected, it can be inferred that someone begins to speak. Since a voice related call is ongoing, it is very likely that the participant generates the voice. Thus, if an existence of a voice is detected, the detected speaking intention of the participant is to speak. Since the voice can be temporality buffered and streamed to other participants of the voice related call, unmuting the participant after the participant beginning to speak does not influence the completeness of voice data.

In an embodiment, detection of an existence of a voice with a predetermined duration is made. In some conditions, the participant may only make a very short sound, like clearing his throat, and it should not be deemed as intention of the participant to speak. Those skilled in the art can design a threshold duration so that if the existence of a voice with a duration equal or larger than the threshold duration is detected, the detected speaking intention of the participant is to speak.

In an embodiment, detection of an existence of a voice with a predetermined volume is made. In some conditions, the participant may only mumble to himself or whispering to others and it should not be deemed as intention of the participant to speak. Those skilled in the art can design a threshold volume so that if the existence of a voice with a volume equal or larger than the threshold volume is detected, the detected speaking intention of the participant is to speak.

In an embodiment, detection of an existence of a voice with a predetermined voiceprint is made. In some conditions, the participant may be accompanied by other people, like child, or in a crowded environment and voice from other people should not be deemed as intention of the participant to speak. The voiceprint of the participant may be obtained in advance and can be stored locally or remotely in cloud server, etc., in association with the participant. If the existence of a voice with a predetermined voiceprint associated with the participant is detected, the detected speaking intention of the participant is to speak.

In an embodiment, detection of an existence of a voice from a predetermined direction is made. The participant is normally positioned within certain area with respect to a microphone collecting his voice. For example, +60/-60 degrees with respect to the microphone. Those skilled in the art can design appropriate direction range according to practical use scenario and/or microphone characteristics. If the existence of a voice from a predetermined direction is detected, the detected speaking intention of the participant is to speak.

In an embodiment, detection of a moving mouth pattern of a face is made. In case a camera can be utilized along with the microphone, detection of a face, a mouth on the face, movement of the mouth and/or movement of areas surrounding the mouth, moving mouth pattern can be made. If the moving mouth pattern of the face satisfying a predetermined pattern for a speaking mouth, the detected speaking intention of the participant is to speak.

In an embodiment, detection of a moving mouth pattern of a predetermined face is made. It is also required that the face needs to be (match) the face of the participant to avoid interference of other people's faces within the range of camera. The face of the participant may be obtained in advance and can be stored locally or remotely in cloud server, etc., in association with the participant. If the moving mouth pattern of the face satisfying a predetermined pattern for a speaking mouth and the detected face matches the face of the participant, the detected speaking intention of the participant is to speak.

In an embodiment, detection of a moving mouth pattern of a face with a first predetermined orientation is made. The first predetermined orientation can be designed by those skilled in the art to reflect that the participant is facing the camera rather than looking aside and talking to people nearby. If the moving mouth pattern of the face satisfying a predetermined pattern for a speaking mouth and the detected orientation of the face matches the first predetermined orientation, the detected speaking intention of the participant is to speak.

The following factors can be deemed as an intention of the participant not to speak: a disappearance of a voice; a disappearance of a voice with a predetermined duration; a disappearance of a voice with a predetermined voiceprint; a disappearance of a voice from a predetermined direction; a stable mouth pattern of a face; a stable mouth pattern of a face with a predetermined duration; a stable mouth pattern of a predetermined face; a stable mouth pattern of a face with a first predetermined orientation; a moving mouth pattern of a face with a second predetermined orientation; a moving mouth pattern of a predetermined face with a second predetermined orientation; a face with a second predetermined orientation; a predetermined face with a second predetermined orientation; and/or a predetermined behavior pattern.

In an embodiment, detection of a disappearance of a voice is made during a time period in which the participant is in a speaking mode, e.g., when voice data is continuously received. The disappearance of the voice may be detected when no voice data is received. If so, the detected speaking intention of the participant is not to speak.

In an embodiment, detection of a disappearance of a voice with a predetermined duration is made. When the participant is in a speaking mode, voice data is continuously received or received with intervals shorter than predetermined threshold. The disappearance of the voice may be detected when no voice data is received for a duration equal to or larger than a predetermined threshold. If so, the detected speaking intention of the participant is not to speak.

In an embodiment, detection of a disappearance of a voice with a predetermined voiceprint is made. Like the above embodiment, this also requires the disappearing voice needs to be the voiceprint of the participant. If the disappearance of a voice with a predetermined voiceprint associated with the participant is detected, the detected speaking intention of the participant is not to speak.

In an embodiment, detection of a disappearance of a voice from a predetermined direction is made. Like the above embodiment, this also requires the disappearing voice needs to be positioned within certain area with respect to a microphone collecting his voice. For example, +60/−60 degrees with respect to the microphone. Those skilled in the art can design appropriate direction range according to practical use scenario and/or microphone characteristics. A directional microphone can be used to assist in picking up voice from only a specific direction, such as voice within 60 degrees left and right in front of the microphone. If the disappearance of a voice from a predetermined direction is detected, the detected speaking intention of the participant is not to speak.

In an embodiment, detection of a stable mouth pattern of a face is made. Like the above embodiment, if the mouth pattern of the detected face satisfies a predetermined pattern for a non-speaking mouth, the detected speaking intention of the participant is not to speak.

In an embodiment, detection of a stable mouth pattern of a face with a predetermined duration is made. Like the above embodiment, if the mouth pattern of the detected face satisfies a predetermined pattern for a non-speaking mouth and for a time period equal to or larger than the predetermined threshold, the detected speaking intention of the participant is not to speak.

In an embodiment, detection of a stable mouth pattern of a predetermined face is made. Like the above embodiment, it is also required that the face needs to be (match) the face of the participant to avoid interference of other people's faces within the range of camera. The face of the participant may be obtained in advance and can be stored locally or remotely in cloud server, etc., in association with the participant. If the mouth pattern of the face satisfying a predetermined pattern for a stable mouth and the detected face matches the face of the participant, the detected speaking intention of the participant is not to speak.

In an embodiment, detection of a stable mouth pattern of a face with a first predetermined orientation is made. Like the above embodiment, the first predetermined orientation can be designed by those skilled in the art to reflect that the participant is facing the camera rather than looking aside and talking to people nearby. If the mouth pattern of the face satisfying a predetermined pattern for a stable mouth and the detected orientation of the face matches the first predetermined orientation, the detected speaking intention of the participant is not to speak.

In an embodiment, detection of a moving mouth pattern of a face with a second predetermined orientation is made. The second predetermined orientation can be designed by those skilled in the art to reflect that the participant is looking aside and talking to people nearby rather than facing the camera. If the mouth pattern of the face satisfying a predetermined pattern for a moving mouth and the detected orientation of the face matches the second predetermined orientation, the detected speaking intention of the participant is not to speak in the voice related call.

In an embodiment, detection of a moving mouth pattern of a predetermined face with a second predetermined orientation is made. Like the above embodiment, it is also required that the face needs to be (match) the face of the participant to avoid interference of other people's faces within the range of camera. If the mouth pattern of the face satisfying a predetermined pattern for a moving mouth and the detected orientation of the face matches the second predetermined orientation and the detected face matches the face of the participant, the detected speaking intention of the participant is not to speak in the voice related call.

In an embodiment, detection of a face with a second predetermined orientation is made. Like the above, if the participant looks aside, he potentially shows that he wants to stop his speaking in the voice related call. If the detected orientation of the face matches the second predetermined orientation, the detected speaking intention of the participant is not to speak in the voice related call.

In an embodiment, detection of a predetermined face with a second predetermined orientation is made. Like the above, it is also required that the face needs to be (match) the face of the participant to avoid interference of other people's faces within the range of camera. If the detected orientation of the face matches the second predetermined orientation and the detected face matches the face of the participant, the detected speaking intention of the participant is not to speak in the voice related call.

In an embodiment, detection of a predetermined behavior pattern is made. The predetermined behavior pattern includes, but not limited to, leaving, picking up a phone and/or holding a phone. These behavior patterns show that the detected person is not interested in speaking in the voice related call. If so, the detected speaking intention of the participant is not to speak in the voice related call.

It is understood that detection of one of, some of, or all of the above factors can be made to detect the speaking intention of the participant.

It is understood the above detections can be made by algorithm and/or AI (Artificial Intelligence).

At block 102, auto switching the muting condition of the participant based on the detected speaking intention of the participant.

In an embodiment, when the detected speaking intention of the participant is to speak, the participant in the voice related call is unmuted.

In an embodiment, when the detected speaking intention of the participant is not to speak, the participant in the voice related call is muted.

FIG. 2 is a block diagram of an apparatus for auto switching muting condition of a participant in a voice related call according to embodiments of the present disclosure.

The apparatus 200 includes a communication interface 201, a processor 202 and a memory 203. The memory 203 contains instructions executable by the processor 202 whereby the apparatus 200 is operative to perform the actions, e.g., of the procedure described earlier in conjunction with FIG. 1.

In some embodiments, the memory 203 may further contain instructions executable by the processor 202 whereby the apparatus 200 is operative to perform any of the aforementioned methods, steps, and processes.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 202 causes the apparatus 200 to perform the actions, e.g., of the procedure described earlier in conjunction with FIG. 1.

The computer program product may be configured as a computer program code structured in computer program modules. The computer program modules could essentially perform the actions of the flow illustrated in FIG. 1.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are 10 given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-12. (canceled)

13. A method of auto switching a muting condition of a participant in a voice related call, comprising:
detecting a speaking intention of a participant in a voice related call; and
auto switching a muting condition of the participant based on the detected speaking intention of the participant.

14. The method of claim 13, wherein the auto switching comprises unmuting the participant in the voice related call when the detected speaking intention of the participant is to speak.

15. The method of claim 13, wherein the auto switching comprises muting the participant in the voice related call when the detected speaking intention of the participant is not to speak.

16. The method of claim 13, wherein the detecting the speaking intention of the participant comprises detecting an existence of a voice or a disappearance of a voice.

17. The method of claim 16, wherein the detecting the speaking intention of the participant comprises at least one of the following:
detecting an existence of, or a disappearance of, a voice with a predetermined duration;
detecting an existence of, or a disappearance of, a voice with a predetermined volume;
detecting an existence of, or a disappearance of, a voice with a predetermined voiceprint; and
detecting an existence of, or a disappearance of, a voice from a predetermined direction.

18. The method of claim 13, wherein the detecting the speaking intention of the participant comprises detecting a moving mouth pattern of a face or a stable mouth pattern of a face.

19. The method of claim 18, wherein the detecting the speaking intention of the participant comprises at least one of the following:
detecting a moving mouth pattern of, or a stable mouth pattern of, a face with a predetermined duration;
detecting a moving mouth pattern of, or a stable mouth pattern of, a predetermined face; and
detecting a moving mouth pattern of, or a stable mouth pattern of, a face with a predetermined orientation.

20. The method of claim 18, wherein the detecting the speaking intention of the participant comprises at least one of the following:
detecting a stable mouth pattern of a face with a first predetermined orientation
detecting a moving mouth pattern of a face with a second predetermined orientation;
detecting a moving mouth pattern of a predetermined face with a second predetermined orientation;
detecting a face with a second predetermined orientation; and
detecting a predetermined face with a second predetermined orientation.

21. The method of claim 13, wherein the detecting the speaking intention of the participant comprises detecting a predetermined behavior pattern.

22. The method of claim 21, wherein the predetermined behavior pattern comprises at least one of: leaving, picking up a phone and holding a phone.

23. An apparatus for auto switching a muting condition of a participant in a voice related call, the apparatus comprising:
a communication interface;
a processor; and
a memory coupled to the processor, said memory containing instructions executable by said processor whereby the apparatus is configured to:
detect a speaking intention of a participant in a voice related call; and
auto switch a muting condition of the participant based on the detected speaking intention of the participant.

24. The apparatus of claim 23, said memory containing instructions executable by said processor whereby the apparatus is configured to unmute the participant in the voice related call when the detected speaking intention of the participant is to speak.

25. The apparatus of claim 23, said memory containing instructions executable by said processor whereby the apparatus is configured to mute the participant in the voice related call when the detected speaking intention of the participant is not to speak.

26. The apparatus of claim 23, said memory containing instructions executable by said processor whereby the apparatus is configured to detect the speaking intention of the participant by detecting an existence of a voice or a disappearance of a voice.

27. The apparatus of claim 26, said memory containing instructions executable by said processor whereby the apparatus is configured to detect the speaking intention of the participant by at least one of the following:
detecting an existence of, or a disappearance of, a voice with a predetermined duration;
detecting an existence of, or a disappearance of, a voice with a predetermined volume;
detecting an existence of, or a disappearance of, a voice with a predetermined voiceprint; and
detecting an existence of, or a disappearance of, a voice from a predetermined direction.

28. The apparatus of claim 23, said memory containing instructions executable by said processor whereby the apparatus is configured to detect the speaking intention of the participant by detecting a moving mouth pattern of a face or a stable mouth pattern of a face.

29. The apparatus of claim 28, said memory containing instructions executable by said processor whereby the apparatus is configured to detect the speaking intention of the participant by at least one of the following:
detecting a moving mouth pattern of, or a stable mouth pattern of, a face with a predetermined duration;
detecting a moving mouth pattern of, or a stable mouth pattern of, a predetermined face; and
detecting a moving mouth pattern of, or a stable mouth pattern of, a face with a predetermined orientation.

30. The apparatus of claim 28, said memory containing instructions executable by said processor whereby the apparatus is configured to detect the speaking intention of the participant by at least one of the following:
detecting a stable mouth pattern of a face with a first predetermined orientation
detecting a moving mouth pattern of a face with a second predetermined orientation;
detecting a moving mouth pattern of a predetermined face with a second predetermined orientation;
detecting a face with a second predetermined orientation; and
detecting a predetermined face with a second predetermined orientation.

31. The apparatus of claim 23, said memory containing instructions executable by said processor whereby the apparatus is configured to detect the speaking intention of the participant by detecting a predetermined behavior pattern.

32. The apparatus of claim 31, wherein the predetermined behavior pattern comprises at least one of: leaving, picking up a phone and holding a phone.
